(19) United States
(12) Patent Application Publication
(10) Pub. No.: US 2026/0166919 A1
(43) Pub. Date: Jun. 18, 2026

(54) RACING WHEEL HUB AND METHOD OF HARDENING SAME

(71) Applicant: AKTIEBOLAGET SKF, GOTEBORG (SE)

(72) Inventors: Sebastian KRAUS, Schwanfeld (DE); Michael WENDEL, Bremen (DE)

(21) Appl. No.: 19/405,686

(22) Filed: Dec. 2, 2025

(30) Foreign Application Priority Data
Dec. 12, 2024 (DE) 102024137293.1

(51) Int. Cl. B60B 27/00; B60B 27/02

(52) U.S. Cl. CPC B60B 27/0094; B60B 27/02; B60B 2310/54

(57) ABSTRACT

A racing wheel hub includes a first outer surface portion configured as a bearing inner ring of a rolling element bearing, the bearing inner ring including an induction hardened raceway configured to support rolling elements of the rolling-element bearing and a non-functional surface that is not configured to support rolling elements of the rolling-element bearing. At least a portion of the non-functional surface of the racing hub is laser hardened. Also a method of hardening a racing wheel hub.

### CROSS-REFERENCE

This application claims priority to German patent application no. 10 2024 137 293.1 filed on Dec. 12, 2024, the contents of which are fully incorporated herein by reference.

### TECHNOLOGICAL FIELD

The present disclosure relates to a racing wheel hub having a laser hardened surface portion.

### BACKGROUND

Due to the accelerations that occur in the field of racing, particularly high loads are exerted on wheel hubs. Furthermore, rims that are disposed on the wheel hubs must be rapidly interchangeable and are, therefore, usually fastened to the wheel hub by only a single screw-and-nut connection. Therefore, this individual screw-and-nut connection is likewise subjected to a high load during operation. In order to be able to withstand these loads during operation, racing wheel hubs are hardened. An induction hardening method or a conventional method, such as martensitic and/or bainitic hardening, is usually used for this purpose.

In order to ensure that the functional surfaces of the racing hub, i.e. those surfaces that serve as running surfaces or friction surfaces, can withstand the loads that occur during operation, the functional surfaces of the racing hubs to date have been induction hardened. This does provide a cost-effective process, but non-functional surfaces, such as the thread for receiving the single fastening nut, are not hardened in the process. This leads to a higher risk of wear and deformation of these surfaces.

Heat treatments according to the prior art, such as martensitic hardening, bainitic hardening, case hardening, nitrogen hardening or induction hardening have may disadvantages. These include the fact that they involve batch processes (except induction hardening) without single piece flow, they require large equipment/furnaces for large hubs (which may not be readily available) and the processes often result in large distortions, which requires oversizing of the soft component and costly post-machining. In addition they involve great complexity in terms of parts handling and logistics, they can lead to surface damage which will then require hard machining in order to remove damaged surfaces (e.g. decarburization, oxidation, etc.), and there are special part-specific tooling costs and associated costs (e.g. inductors for induction hardening). Furthermore, the prior art processes require long set-up times when changing parts in production, a lack of the possibly to perform selective hardening (exception: induction hardening), and they require large installation spaces for heat treatment plants.

### SUMMARY

It is therefore an aspect of the present disclosure to provide a racing hub which is cost-effective in production and, as an entity, can withstand the loads in racing.

The disclosed racing wheel hub is configured as a bearing inner race for a rolling bearing and has on the external side at least one raceway for rolling elements of the rolling bearing. The functional surfaces of the racing hub can be hardened by known heat treatment methods such as an induction hardening method, for example. In this context, a functional surface of the racing hub is understood to be a raceway or running surface or a friction surface.

As opposed to conventional racing hubs, in which the non-functional surfaces are either also induction hardened, or not hardened at all, at least one of the non-functional surfaces of the racing hub proposed herein is laser hardened.

In this context, non-functional surfaces are understood to be all surfaces with the exception of the running surface or friction surface, i.e. all non-running surfaces. For example, the non-functional surfaces can be part of a thread which is used for disposing the rim on the racing wheel hub with the aid of a screw-and-nut connection, or they can be other surfaces which have to be wear-resistant or protected against deformation, or have to have a specific strength, such as surfaces onto which other components are shrunk or to which other components are fastened, or surfaces that come into contact with other components.

By using a laser heat treatment for hardening this at least one non-functional surface, the at least one non-functional surface can be heated, and thus hardened, in a highly targeted manner. Furthermore, the process of laser hardening does not require post-machining and can be carried out as the final manufacturing step in a single operation, or be carried out in combination with soft machining, e.g. in a lathe. Moreover, the above-mentioned disadvantages are overcome by using laser hardening.

During laser hardening, the steel components are heat-treated locally in such a way that a martensitic structure is generated by rapid laser heating and subsequent cooling, above all by heat conduction. If required for reasons of geometry and/or due to the limited hardening capability of the steel used, additional quenching media (e.g. compressed air or water) can be used in order to accelerate the cooling rate.

Laser hardening is distinguished by a limited input of energy/heat and thus by low energy consumption and associated low CO₂ emissions, low distortion and limited or no surface oxidation. This offers the opportunity to skip subsequent hard machining steps for removing surface damage, such as oxide layers/decarburized surfaces/scale, which would be created in conventional hardening methods, and to integrate the hardening process into soft machining. As a result, the throughput time and the complexity in terms of handling and logistics in the manufacturing chain can be reduced.

Furthermore, laser hardening is distinguished by a high energy density and a short process time. It is likewise advantageous that only a small volume is subjected to the process, or only a small part of the workpiece cross section is treated, and that process gases are not required. As has already been mentioned above, quenching the workpiece after heating can be dispensed with, as quenching takes place above all by heat conduction in the component. This has the advantages that neither a quenching medium nor pumps for quenching or cooling the plant are required. Furthermore, the same laser source and optics can be used for different workpiece geometries, so that part-specific tools are not necessary.

A further advantage of laser hardening lies in that only very little or even no distortion occurs on the bearing component during laser hardening so that cost-intensive post-machining, in particular complex hard machining, can be partially or completely avoided. This moreover has the advantage that less material has to be added because less deformation takes place, this meaning better material utilization and likewise saving costs and energy/CO2.

Moreover, the laser hardening process can be integrated into the soft machining procedure (e.g. turning, etc.), thus into the machining prior to the actual hardening and/or into the hard machining process (e.g. grinding, honing), thus the post-hardening machining, whereby even integration into existing machines is possible. Moreover, a flexible laser hardening apparatus can be integrated into soft machining, or else into the hard machining unit, which can reduce the cycle time and increase productivity to a great degree.

Since not only the functional surfaces but also the non-functional surfaces are hardened, wear particles and surface damage during a relative movement or an operating error of the racing hub can be more comprehensively avoided. Furthermore, the combination of induction-hardened and laser hardened surfaces can reduce distortion of the racing hub, which in turn requires less hard machining, thus saving costs and energy.

In particular, the functional faces can be subjected to induction hardening. The other surfaces are not affected by the induction heat treatment and have the initial hardness of the soft components (e.g. 20 to 40 HRC). Typical steel grades are all steel grades that are capable of being hardened with the following exemplary chemical composition: carbon (0.40-1.10% by weight), silicon (0.15-0.35% by weight), manganese (0.60-1.10% by weight), chromium (0.30-2.00% by weight), and molybdenum (0.10-0.75% by weight).

The laser hardening process of the non-functional surface(s) leads to a lesser hardening depth (up to 2 mm max.) in order to generate a hard and wear-resistant volume on the non-functional surfaces which, in contrast to the raceways, for example, are not subjected to rolling contact but to frictional contact, for example. As a result of the laser hardening process, the wear resistance for the avoidance of excessive wear and the strength for the avoidance of excessive plastic deformation are increased.

According to one embodiment, the nun-functional surface is a thread on the external side of the racing wheel hub, which is designed to receive a nut for fastening a wheel. The thread is subjected to frictional contact on the threaded tip and the flanks, and to a certain contact pressure on the flank when tightening the nut. Excessive signs of wear, plastic deformation and breakage of the thread, or of parts of the thread, can be avoided by targeted laser hardening, for example to a hardness of >45 HRC.

Alternatively, the non-functional surface can be other surfaces of the racing hub outside the raceway. These include, for example, sealing surfaces that are subjected to friction contact in relation to the seal and should have a certain hardness in order to avoid wear, in particular a hardness >50 HRC; surfaces to which other components are fastened or onto which other components are shrunk which should likewise be hardened (in particular to >45 HRC) in order to avoid seizing when cold, due to micro-movements between the two components, and signs of wear during assembly; external diameter, lateral surface/shoulder of an outer race and internal diameter, lateral surface/shoulder of an inner race.

According to a further embodiment, the thread is at least partially hardened. In particular, the tips of the thread can be laser hardened, and the flanks of the thread can transition from the laser hardened tips into a non-hardened region in the thread flight. Alternatively or additionally, a first turn of the thread can be laser hardened.

By hardening the first turn of the thread, the region on which a nut for disposing the rim on the racing hub is first placed can in particular be hardened. This is the region in which particularly high loads act on the thread (caused by mounting the nut). If this initial region of the thread is specifically hardened, signs of wear and deformations on the racing hub can be avoided when disposing the rim, in particular at the beginning, when placing the nut on the racing hub. Furthermore, the tips of the thread can be hardened, because the tips, like the first turn, are likewise subjected to higher loads in comparison to the thread flanks. Therefore, there can be a transition at the thread flanks between a hardened region (>50 HRC) and a non-hardened region (20-35 HRC) in the thread flight.

As has already been explained above, the hardening depth of the at least one non-functional laser hardened surface can be at most 2 mm, in particular at most 1.5 mm. Hardening depth in this context is understood to be the region in which a phase conversion of the initial material, from a ferritic basic structure to a martensitic structure, takes place due to the thermal input by the laser. In other words, during laser hardening of the at least one non-functional surface, a converted peripheral layer, which is adjoined by the non-converted basic structure, extends over the hardening depth.

The hardness of the at least one non-functional laser hardened surface can be more than 45 HRC, in particular more than 50 HRC. As has already been explained above, this hardness is sufficient for protecting the at least one non-functional surface against wear.

According to a further embodiment, the surface of the at least one non-functional laser hardened surface has a texture. The texture can be designed, for example, to increase the coefficient of friction of the surface. Furthermore, the texture can form lubrication grooves and/or a lubricant reservoir.

As has been mentioned above, a microstructural change of phase takes place during laser hardening, which leads to a change in the specific volume, or to a change in the density of the physical phases, for example during the conversion into martensite and/or bainite. The hardened and converted regions have a larger volume than in the initial phase, and lead to an elevation of the laser hardened surfaces in the micrometer range. In the process, surface regions which have been hardened to a greater depth are elevated to a greater extent than surface regions which have been hardened to a lesser depth, or have not been hardened at all. As a result, a specific surface texture and topology can be applied to the non-functional surface. An arbitrary number of surface regions with different hardening depths can be provided here, in order to further refine the surface texture, for example.

Alternatively, the texture can also be created by partial melting of the surface (formation of craters), or else as a result of internal inherent stresses which may be caused by the heat treatment of the surfaces.

Thus, as has already been explained above, the differently hardened regions can be disposed in such a manner that one region forms a lubricant reservoir and/or a lubricant groove that is delimited by another region. This advantageously contributes towards reducing wear in the case of frictional contact. Moreover, it can be ensured as a result that lubricant can be kept at specific locations on the racing hub and/or be directed to specific locations.

In this way, a “golf ball topography” can be generated, for example, in order to achieve lubricating pockets and to improve the lubricating conditions as a result. As has been mentioned above, this can be achieved either by selective hardening of local regions, or by a variable hardening depth. The depressions created act as lubricant reservoirs.

This behavior, or this characteristic, can also be utilized for generating textures for increased friction on the non-functional surfaces, in particular non-functional contact surfaces, so as to avoid, for example, a relative movement (e.g. creeping) between the racing hub and contact partners (housing/shaft). As a result of a form-fit or a friction-fit with a very high coefficient of friction impeding the relative movement between the racing hub and the counterpart in the application, a looser tight fit/a smaller contribution of the force-fit can be achieved, this in turn leading to lower tensile stresses in the racing hub (e.g. racing hub shrunk onto shaft) and to a longer component lifespan.

Therefore, an exemplary embodiment is also advantageous in which the at least one non-functional surface has a first surface region which is laser hardened to a first hardening depth and has a first coefficient of friction, and a second surface region which is hardened to a second lesser hardening depth and/or a third surface region which has a second or third coefficient of friction, respectively, wherein the first coefficient of friction is higher than the second and/or the third coefficient of friction.

The relative movement between the racing hub and a counterpart (e.g. a shaft or a rim or a wheel) in the application can be impeded by the targeted increase of the coefficient of friction of the racing hub at specific locations. Increasing the coefficient of friction and also the special design of the surface texture can enable a looser tight fit, or a smaller contribution of the force-fit, which in turn leads to lower tensile stresses in the racing hub and to a longer lifespan.

According to a further embodiment, the laser hardened region of the at least one non-functional surface is of continuous design.

It can be achieved as a result of the non-functional surface, in particular the thread, being embodied without any soft spot on the entire circumferential surface, this ensuring, for example, a uniform increase in the coefficient of friction and thus a uniform transmission of force. This can be achieved using one or a plurality of laser heads. Alternatively, of course, it can also be advantageous when the laser hardened region of the at least one non-functional surface is designed as discrete surface region portions.

Thus, a soft non-laser hardened region can be provided on the complete circumferential surface between the starting position and the end position of a scanning procedure, for example, or even a plurality of soft regions which form a specific pattern can be enabled. Thus, the hardening can be designed, for example, as a plurality of rectangles/squares, a plurality of circular and/or oval regions (e.g., small enough to be described as “point-like”), a plurality of triangles, or else as zigzag shapes, optionally with different angles.

The patterns herein can contain further functions, such as the above-mentioned lubricant reservoirs or grooves, for example. However, the patterns can also be designed only as specific designs which assign the racing hub to the applicant as a manufacturer already due to their visual appearance, for example.

According to a further embodiment, the laser hardened region has at least one soft spot or soft seam, wherein the soft spot/soft seam is disposed in a non-stressed region of the laser hardened region, and/or wherein the soft spot/soft seam is disposed at an angle relative to the direction of stress. There can be one soft spot/soft seam, or a plurality of soft spots/soft seams.

A soft spot/soft seam of this type can also be created, for example, in that an already hardened region is re-heated. This can be performed, for example, in that the laser, which scans the surface to be hardened, again sweeps across already heated and cooled regions of the surface to be hardened. Soft spots of this type are not necessarily critical, in particular in the case of non-functional surfaces, because the latter are usually subjected to lower stress and local small-area soft spots are not critical if the surface is otherwise hardened. As a result, the hardening method can be significantly simplified because complex hardware or process management, in particular also for preheating, or similar, which would be required for slippage-free hardening, thus hardening without a soft spot or soft seam, can be dispensed with.

In principle, the non-functional surface can be hardened with a soft seam or without a soft seam by means of laser hardening. The soft spot or soft seam is preferably aligned in the axial direction, or perpendicularly to the direction of load. In order to achieve a better distribution of load and stress, according to a further embodiment, the soft seam can be embodied at an angle other than parallel to the axial direction of the racing hub.

As has already been explained above, functional surfaces of the racing hub can be induction hardened. In particular, according to one embodiment, the raceway can have an induction hardened running surface. Induction hardening is an established surface hardening method. In comparison to laser beam hardening, slippage-free hardening zones can be generated in a relatively simple manner, even down to a depth of several (e.g., 3 or more) millimeters. Hardware and induction tools form the prior art and are therefore readily available.

According to a further embodiment, the racing hub has a soft zone between the induction hardened running surface and the at least one non-functional laser hardened surface. This soft zone can be created as a non-hardened zone between the induction hardened running surface and the at least one non-functional laser hardened surface. The soft zone can also be created by reheating an already-hardened, in particular induction hardened, region, in particular by a process in which the laser, which scans the surface to be hardened, again sweeps across already heated and cooled regions of the induction hardened region.

The soft zone between the induction hardened running surface and the laser hardened surface has the following advantages: less energy input (CO₂) is required due to the avoidance of hardening non-relevant regions (which do not require increased strength), the original toughness remains unchanged, so that shock-like loads can be absorbed (no brittle martensite); and no mutual influence of the two heat treatments (thermal influence).

Another aspect of the disclosure comprises a method of providing a racing wheel hub having a first outer surface portion configured as a bearing inner ring of a rolling element bearing, the bearing inner ring including a raceway configured to support rolling elements of the rolling-element bearing and a non-functional surface that is not configured to support rolling elements of the rolling-element bearing, induction hardening the raceway, and laser hardening at least a portion of the non-functional surface. The non-functional surface may be an external thread of the racing wheel hub that is configured receive a nut for fastening a wheel to the racing wheel hub, the induction hardening may comprise induction hardening the raceway to a depth of at least 3 mm, and the laser hardening may comprise laser hardening at least a portion of the thread to a hardness of at least 45 HRC and to a depth of less than or equal to 2.0 mm.

Further advantages and advantageous embodiments are set forth in the description, the drawings and the claims. In particular, the combinations of features set forth in the description and in the drawings is purely exemplary, such that the features may also be present individually or in other combinations.

### BRIEF DESCRIPTION OF THE DRAWINGS

The disclosure is described in more detail hereinafter by means of exemplary embodiments illustrated in the drawings. The exemplary embodiments and the combinations shown in the exemplary embodiments are purely exemplary and are not intended to establish the scope of protection of the disclosure. The latter is defined solely by the appended claims.

FIG. 1 is a sectional view of a racing hub according to an embodiment of the present disclosure.

FIG. 2 is a perspective view of a portion of a thread of the racing hub of FIG. 1.

FIG. 3 is a schematic sectional view of a thread profile of the thread of FIG. 2.

### DETAILED DESCRIPTION

Identical of functionally equivalent elements are provided with the same reference signs hereunder.

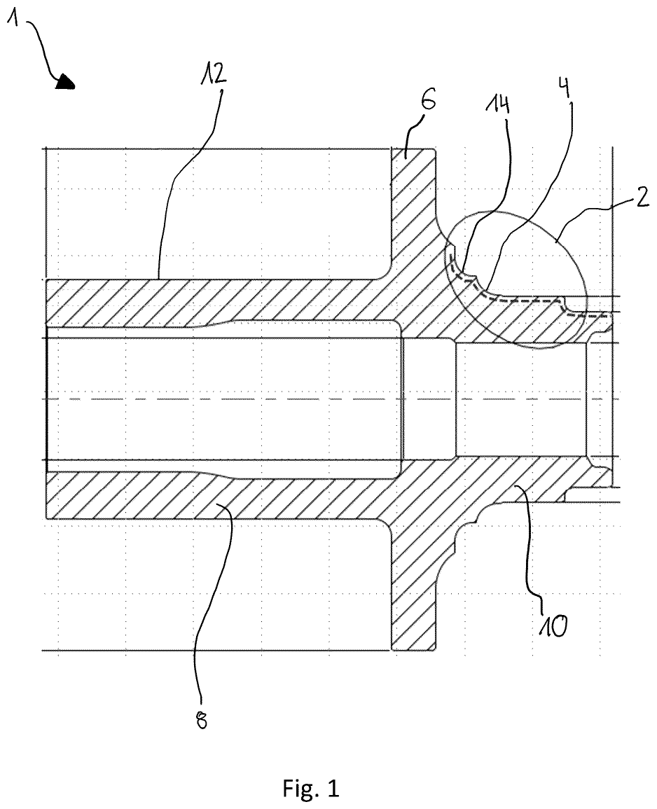

FIG. 1 shows a racing hub 1 which is designed as a bearing inner race for a rolling bearing (not shown). For this purpose, the racing hub 1 has different surfaces 2 for the rolling bearing. These include, inter alia, a raceway 4 for rolling members of the rolling bearing, and a seal seat 14 on which a seal for sealing the rolling bearing can be disposed. The running surface 4 is also referred to as (is an example of) a functional surface.

The functional surface 4 is disposed on or at the edge of a cylindrical portion 10 of the racing hub. This portion 10 is separated from a further portion 8 by a flange 6, the further portion 8 in turn having at least one non-functional surface 12, in this case a thread for receiving a nut (not shown). This thread 12 can be used, for example, for fastening a rim to the racing hub 1. However, when screwing on the nut required for this purpose, the thread 12 is subjected to loads which may damage the thread.

Until now, the non-functional surfaces, such as, e.g. the thread 12, have not been hardened, in particular for cost reasons, but only the functional surface 4 has been hardened by an induction hardening process. This has led to the set of issues described above, pertaining to potential damage to the thread 12, for example.

Therefore, the at least one non-functional surface of the racing hub shown here is hardened, specifically by means of a laser hardening process. This has the advantage, inter alia, that the non-functional surface can be hardened in a targeted manner without any thermal influence affecting other regions which have already been hardened.

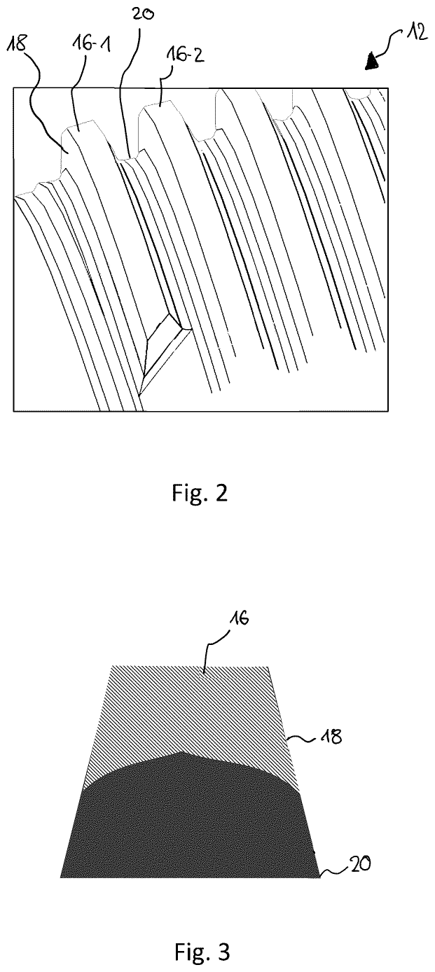

A thread 12 as a non-functional surface will be described in more detail hereinafter with reference to FIGS. 2 and 3. As shown in FIG. 2, the thread 12 includes a plurality of turns 16-1, 16-2 which comprise a thread flight 12 and threaded tips (16 in FIG. 3) which by way of thread flanks 18 transition into the thread flight 20. Advantageously, the first turn 16-1 of the thread 12 is in particular hardened. This first turn 16-1 is the turn which is first contacted by a nut and is therefore subjected to the highest loads and the highest wear. If specifically this first turn 16-1 is laser hardened, this first turn 16-1 heavy wear and/or deformation can be prevented when screwing on a nut.

Furthermore, the threaded tips 16 can in particular be hardened by the laser hardening process. The flanks 18 of the thread 12 transition from the laser hardened tips 16 into a non-hardened region in the thread flight 20. This is in particular due to manufacturing reasons and has the advantage that the tips 16, which, like the first thread turn 16-1, are potentially subjected to a higher load, are hardened, and wear on the thread 12 can be reduced as a result. This transition of the hardened region into a non-hardened region is also illustrated by way of example in FIG. 3. As can be seen, the region of the threaded tips 16 (hatched region) is hardened and transitions into a non-hardened region (white region). This can also be a smooth transition.

As has already been explained above, very precise hardening of different non-functional surfaces is possible as a result of the laser hardening process. This is particularly advantageous in the region of the thread 12, because only the tips 16 or the first thread turn 16-1, or other regions of the thread, can be hardened in a targeted manner.

A method according to the disclosure includes providing a racing wheel hub having a first outer surface portion configured as a bearing inner ring of a rolling element bearing, the bearing inner ring including a raceway configured to support rolling elements of the rolling-element bearing and a non-functional surface that is not configured to support rolling elements of the rolling-element bearing, induction hardening the raceway, and laser hardening at least a portion of the non-functional surface. The non-functional surface may be an external thread of the racing wheel hub that is configured receive a nut for fastening a wheel to the racing wheel hub, the induction hardening may comprise induction hardening the raceway to a depth of at least 3 mm, and the laser hardening may comprise laser hardening at least a portion of the thread to a hardness of at least 45 HRC and to a depth of less than or equal to 2.0 mm.

In summary, a racing hub which, by virtue of the laser hardened non-functional surfaces, has a longer lifespan in comparison to conventional racing hubs is provided here.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved racing wheel hubs and methods for forming same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE SIGNS

1 Racing hub
2 Surfaces for rolling bearing
4 Raceway
6 Flange
8 First portion
10 Second portion
12 Thread seat
14 Seal seat
16 Threaded tip
16-1, 16-2 Turns
18 Thread flank
20 Thread flight

What is claimed is:

1. A racing wheel hub comprising:
a first outer surface portion configured as a bearing inner ring of a rolling element bearing, the bearing inner ring including an induction hardened raceway configured to support rolling elements of the rolling-element bearing, and
a non-functional surface that is not configured to support rolling elements of the rolling-element bearing,
wherein at least a portion of the non-functional surface of the racing hub is laser hardened.

2. The racing wheel hub according to claim 1,
wherein the non-functional surface is an external thread of the racing wheel hub, the thread being configured receive a nut for fastening a wheel to the racing wheel hub.

3. The racing wheel hub according to claim 2,
wherein tips of the external thread are hardened and a portion of a thread flight is not hardened.

4. The racing wheel hub according to claim 2,
wherein a first turn of the thread is laser hardened and second and subsequent turns of the thread are not hardened.

5. The racing wheel hub according to claim 1,
wherein a hardening depth of the at least a portion of the non-functional surface is less than or equal to 2 mm.

6. The racing wheel hub according to claim 1,
wherein a hardening depth of the at least a portion of the non-functional surface is less than or equal to 1.5 mm.

7. The racing wheel hub according to claim 1,
wherein a hardness of the at least a portion of the non-functional surface is greater than or equal to 45 HRC.

8. The racing wheel hub according to claim 1,
wherein a hardness of the at least a portion of the non-functional surface is greater than or equal to 50 HRC.

9. The racing wheel hub according to claim 1,
wherein the raceway has an induction hardened surface.

10. The racing wheel hub according to claim 9,
wherein the racing wheel hub has a zone having a hardness of 20 HRC to 40 HRC between the raceway and the non-functional surface.

11. The racing wheel hub according to claim 1,
wherein the raceway is induction hardened to a depth of at least 3 mm,
wherein the non-functional surface is an external thread of the racing wheel hub, the thread being configured receive a nut for fastening a wheel to the racing wheel hub,
wherein a first turn of the thread is laser hardened to a hardness of at least 50 HRC to depth of less than or equal to 1.5 mm, and
wherein a zone between the raceway and the non-functional surface has a hardness of 20 HRC to 40 HRC.

12. A method comprising:
providing a racing wheel hub having a first outer surface portion configured as a bearing inner ring of a rolling element bearing, the bearing inner ring including a raceway configured to support rolling elements of the rolling-element bearing and a non-functional surface that is not configured to support rolling elements of the rolling-element bearing,
induction hardening the raceway, and
laser hardening at least a portion of the non-functional surface.

13. The method according to claim 12,
wherein the non-functional surface is an external thread of the racing wheel hub, the thread being configured receive a nut for fastening a wheel to the racing wheel hub,
wherein the induction hardening comprises induction hardening the raceway to a depth of at least 3 mm, and
wherein the laser hardening comprises laser hardening at least a portion of the thread to a hardness of at least 45 HRC and to a depth of less than or equal to 2.0 mm.

14. The method according to claim 12,
wherein the non-functional surface is an external thread of the racing wheel hub, the thread being configured receive a nut for fastening a wheel to the racing wheel hub,
wherein the induction hardening comprises induction hardening the raceway to a depth of at least 3 mm, and
wherein the laser hardening comprises laser hardening at least a portion of the thread to a hardness of at least 50 HRC and to a depth of less than or equal to 1.5 mm.

15. The method according to claim 14,
wherein the laser hardening comprises laser hardening a first turn of the thread without laser hardening a second turn of the thread.

16. The method according to claim 14,
wherein the laser hardening comprises laser hardening a tip of the thread without laser hardening a flight of the thread.
